(19) United States
(12) Patent Application Publication
(10) Pub. No.: US 2011/0274792 A1
(43) Pub. Date: Nov. 10, 2011

(54) METHOD FOR PRODUCING POWDER FOR SUPPLEMENTARY FOOD AND SUPPLEMENTARY FOOD

(75) Inventors: Kokichi Hanaoka, Nagano (JP); Yoshiaki Matsuo, Tokyo (JP); Ryouichi Ohtsubo, Tokyo (JP); Atsuyoshi Murakami, Tokyo (JP)

(73) Assignee: INVESTMENT DESIGN, INC., Tokyo (JP)

(21) Appl. No.: 13/054,485

(22) PCT Filed: Jul. 15, 2009
(86) PCT No.: PCT/JP2009/003329

§ 371 Date: May 2, 2011

(30) Foreign Application Priority Data
Jul. 15, 2008 (JP) JP2008-183558
Sep. 30, 2008 (JP) JP2008-252278

(51) Int. Cl. A23L 1/304; A23P 1/02

(52) U.S. Cl. 426/97; 426/473; 426/648

(57) ABSTRACT

[OBJECT]

The object of the present invention is to provide a method for producing a food supplement in powder form to which hydrogen gas is adsorbed.

[SOLUTION]

Seashells have a layered structure containing CaCO₃ as the principal component before calcination.

Conchiolin, a protein characteristic to seashells, is sandwiched between layers to maintain a fixed shape.

This protein is not removed under a usual condition. Therefore, it is inferred from analytical results described later as well that a protein-derived hydrogen gas is adsorbed and retained between layers.

### FIELD OF THE INVENTION

The present invention relates to a method for producing a food supplement in powder form to which hydrogen gas is adsorbed (attached) and which has an excellent ability to retain the adsorbed hydrogen gas, and said food supplement powder being in a form suitable for ingestion.

### BACKGROUND ART

Patent document 1 describes that coral, oyster shell or zeolite based on calcium silicate has a fine porous structure, and then those are widely used as adsorbent for gas and organic material.

Patent document 2 describes about zeolite which is the materials for a granulation body, inside of this granulation body is hollow, also in Patent document 2, food industry is exemplified as a field of the utilization of the granulation body and the hydrogen occlusion is exemplified as a function of a granulation body, too.

Patent document 3 describes a method comprising drying a powder of coral calcium, oxidatively calcinating the powder at 700° C. for 4 h, and then reductively calcinating the powder in a reduction furnace having an N₂ and H₂ gas atmosphere at 650° C. for 4 h to adsorb negative hydrogen ions.

Patent document 4 discloses production of a supplementary food by mixing coral calcium powder having negative hydrogen ions adsorbed thereto with a brown rice powder or a soy milk powder in this method disclosed in Patent document 3.

Furthermore, a health food produced by adsorbing negative hydrogen ions into coral powder is introduced in a website (www.kenko-suiso.com) on the Internet and the like.

Non-patent document 1 discloses the relationship between a hydrogen ion and the active oxygen, so that, a hydrogen ion is effective for a cell disorder caused by Ischaemia-Reperfusion.

### PRIOR ART

### Patented Documents

[Patent document 1] Japanese Patent Laid-Open No. 2005-2452657
[Patent document 2] Japanese Patent Laid-Open No. 2005-245265
[Patent document 3] Japanese Patent Laid-Open No. 2005-245265
   [Patent document 4] Japanese Patent Laid-Open No. 2005-245265

### Non-Patented Documents

[Non-Patent document 1] Nature Medicine 007 5/8

### DISCLOSURE OF THE INVENTION

### Object of the Invention

As described in Non-Patent document 1, binding of a hydrogen ion and an electron constituting a hydrogen molecule to a free radical is conventionally thought of as effective means for destroying active oxygen in the body.

However, effective result cannot be expected, when drink the water which dissolved hydrogen gas, either take zeolite or coral described in Patent document 1 and 2 in the body as an oral supplement.

The first cause of the above-mentioned result is that the quantity of hydrogen gas dissolved in water is not sufficient to destroy active oxygen in the body, and it is difficult for zeolite or coral to adsorb a sufficient quantity of hydrogen gas.

Also, surface area of natural coral (weathering coral) is about 1 m²/g, and surface area of the zeolite is about 300 m²/g, that is, there are relatively large holes on the surface of the coral. The size of the hole is about 5 nm-50 nm in which hydrogen gas is adsorbed and held. Because the hole of the coral surface is too large, even if coral is put in hydrogen gas, most of the hydrogen gas is not held.

On the other hand, the pore of the zeolite is extremely small, for example, the pore diameter of the mordenite is several nm. It is thought that hydrogen gas can be held if it is such small size, however, most of the hydrogen gas is not held even if synthetic zeolite is put in hydrogen gas. The reason for this is that the diameter of the pore is too small, then hydrogen gas is hard to be put to the pore.

Furthermore, in Patent document 3 and 4, a negative hydrogen ion is recognized as active hydrogen (hydride ion), in which one electron is further added to a hydrogen molecule. However, when a negative hydrogen ion itself is ingested into an organism, an electron may be released and react with oxygen to introduce active oxygen species including superoxide, which is harmful to the body. Furthermore, calcium hydride (CaH₂), in which a negative hydrogen ion is adsorbed to calcium, is very strongly basic. When it is brought into contact with water (H₂O), it vigorously reacts with water to generate hydrogen. When calcium hydride is brought into direct contact with a metal, an explosion may occur, and it is designated as a hazardous material under the Fire Defense Law. Therefore, as it is, calcium hydride cannot be used in vivo.

The second cause of not yielding effective results can be the extreme pH level in the stomach. Even if a porous body such as coral or zeolite to which a sufficient quantity of hydrogen gas is adsorbed is ingested from the mouth, hydrogen ions are consumed as hydroxy-ions (OH⁻) to neutralize the gastric acid and cannot be taken up into the body.

### Means of Solving the Problems

The present inventors found that hydrogen gas is primarily absorbed from the intestinal tract wall, in particular, epithelial cells in the mucous membrane of the small intestine. Since hydrogen taken up from the intestinal tract wall into the body is gaseous, it can be taken up into the cell and the nucleus. The hydrogen binds to active oxygen in the body, resulting in loss of the activity of active oxygen.

Based on this finding, they concluded that a carrier for feeding hydrogen gas into the body is not water, but is preferably a solid, and when a solid retains hydrogen gas, an action prolonged to some extent is required, and accomplished the present invention.

Specifically, the method for producing a supplementary food powder of the present invention comprises: crushing coral, seashell (for example oyster shell, pearl oyster shell), or pearl that contains conchiolin (protein) between CaCO₃ layers; and calcinating (carbonizing) this crushed coral, seashell or pearl in a nonoxidative atmosphere to convert the conchiolin (protein) to low molecular weight compounds, so that hydrogen gas generated during conversion to low molecular weight compounds is physically adsorbed and retained in a gap left between CaCO₃ layers compressed by elimination of the conchiolin (protein).

As preferable condition of the calcination, a nitrogen gas atmosphere, 300-500 degrees Celsius, 2-8 hours.

In the case of a coral and an oyster, the microporosity of several nm diameter does not exist, the macropore with 50 nm or more diameter exist. Thus, hydrogen gas does not remain in a micropore like zeolite. It is thought that the organic body which existed between layers disappears, and space is formed, and during the calcinations, the space is destroyed into narrow gap, hydrogen gas just retains in this gap.

The supplementary food of the present invention comprises: a powder having hydrogen gas physically adsorbed and retained between CaCO₃ layers or a compact having the powder molded into a predetermined shape; and an enteric (alkali soluble) coating on the surface of the powder.

Furthermore, another supplementary food of the present invention comprises: an enteric (alkali soluble) capsule containing the compact.

When the quantity of dissolved hydrogen (DH) after dissolved in pure water (1 L) is 0.25 ppm or more (25° C., 1 atm), the powder for a supplementary food of the present invention can be expected to have an adequate effect as a supplementary food.

Whether the powder for a supplementary food of the present invention has been obtained or not, that is, whether hydrogen gas is adsorbed and retained or not can also be verified by measuring an oxidation reduction potential. Specifically, when the powder for a supplementary food of the present invention in which hydrogen gas is physically adsorbed and retained and a powder for a supplementary food in which hydrogen gas is not physically adsorbed and retained are dissolved in the same water at the same concentration, the difference in the oxidation reduction potential of these aqueous solutions is −20 to −300 mV.

Similarly, when the powder for a supplementary food of the present invention in which hydrogen gas is physically adsorbed and retained is dissolved in water, and a saturated silver chloride electrode is used as a comparison electrode, the oxidation reduction potential is 0 to −400 mV.

### Effect of the Invention

A large quantity of hydrogen gas is adsorbed and retained in the powder for a supplementary food of the present invention, which reaches the intestines and gradually releases the hydrogen gas. Therefore, hydrogen gas is taken up from the intestinal tract wall (epithelial cells of the mucous membrane in the small intestines) into the body, and a hydroxy radical (—OH), a very highly reactive and very toxic active oxygen species, is eliminated as shown in the following reaction formula, so that tissue damage by hydroxy radicals can be prevented in vivo.

H₂+2.OH→2H₂O

This is because, as shown in the above-mentioned formula, a hydroxy radical shows strong nucleophilicity as compared with a superoxide radical.

### BRIEF DESCRIPTION OF THE DRAWINGS

FIG. 1(A) is a cross-sectional schematic view of a conchiolin (protein)-containing seashell as the powder for a supplementary food of the present invention before calcination,

FIG. 1(B) is a schematic view after calcination;

FIG. 2(A) is a view showing a compact obtained by granulating a powder for supplementary food in which hydrogen gas is adsorbed and retained, the compact having an enteric-coating surface thereof,

FIG. 2(B) is a view showing the powder for a supplementary food contained in an enteric capsule.

### PREFERRED EMBODIMENTS OF THE INVENTION

Hereafter, preferred embodiments of the present invention will be explained with reference to the accompanying drawings.

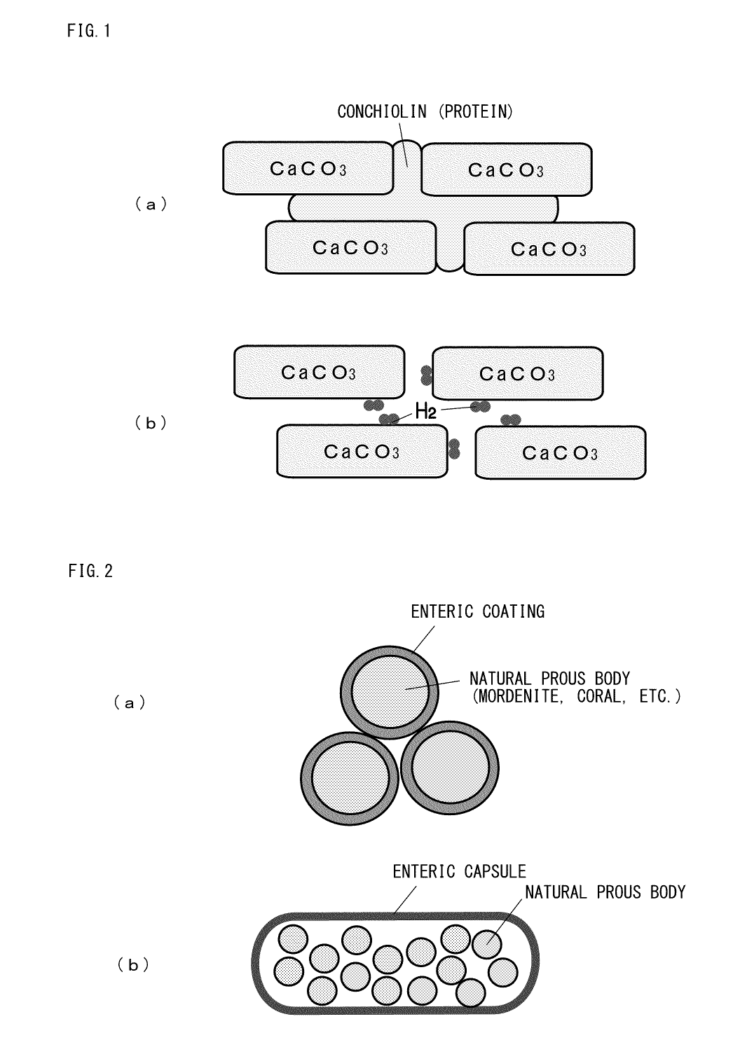

As shown in FIG. 1(a), seashells have a layered structure containing CaCO₃ as the principal component before calcination.

Conchiolin, a protein characteristic to seashells, is sandwiched between layers to maintain a fixed shape. This protein is not removed under a usual condition. Therefore, as shown in FIG. 1(B), it is inferred from analytical results described later as well that a protein-derived hydrogen gas is adsorbed and retained between layers.

The following table shows results of calibration of H₂ concentrations of the powder for a supplementary food of the present invention.

TABLE 1
<H2>:

ppm(v/v)

| | | CORAL-1 | CORAL-2 | CORAL-3 |
|---|---|---|---|---|
| 0 | min | 15.10 | 12.30 | 12.14 |
| 35 | min | 14.83 | 11.67 | 8.41 |
| 70 | min | 10.43 | 11.44 | 8.60 |
| 125 | min | 9.42 | 11.32 | 10.39 |
| 175 | min | 9.88 | 12.06 | 11.99 |
| 275 | min | 14.44 | 17.59 | 14.40 |
| 355 | min | 15.88 | 21.36 | 20.08 |
| 1435 | min | 170.40 | 202.35 | 147.95 |
| 2870 | min | 443.84 | 528.63 | 410.61 |
| 4310 | min | 764.01 | 905.50 | 741.02 |

Coral-1 was obtained by placing a powder of a crushed and dried coral in an airtight container, replacing the atmosphere in an airtight container with a nitrogen gas, and performing calcination (carbonization) in a nonoxidative atmosphere at 450° C. for 3 hours.

Coral-2 was obtained by placing 50 g of a powder of a crushed and dried coral in a 300-mL recovery flask, loading the flask on a rotary evaporator, reducing the pressure with a vacuum pump (4 to 5 mmHg), and recovering the pressure to the normal pressure with hydrogen gas, and taking the coral after repeating the procedure three times.

Coral-3 was obtained by placing 50 g of a powder of a crushed and dried coral in a 300-ml autoclave, replacing the atmosphere with 0.5 Mpa of hydrogen gas three times, increasing the hydrogen gas pressure to 0.8 Mpa, and allowing the powder to stand for 1 h.

For calibration of the H₂ concentrations, a glass dilution bottle having a volume of 1200 mL was filled with N₂, then 1.2 mL of H₂ gas was added and mixed well. At this time, the H₂ concentration in the bottle was 1000 ppm. This gas was injected twice into a gas chromatograph (GC) to obtain the H₂ peaks. The H₂ calibration factors were obtained from the peak areas.

For quantification of the samples, 1 g of a sample was placed in a glass headspace vial having an internal volume of 22 mL, then 10 mL of pure water was added, and the vial was immediately sealed using a Teflon (registered trade mark)-lined silicon rubber with an aluminium cap. The mixture was vigorously shaken and then allowed to stand at room temperature, and 0.5 mL of the gas phase in the container was collected with a gastight syringe and injected into the GC.

The analytical conditions are as follows;

Gas chromatogram: Shimadzu GC-14B
Data processing device: Shimadzu Chromatopac C-R7A′
Column: Molecular Sieve-5A 60-80 mesh, 2 m
Column temperature: 50° C.

### Detector: TCD

Current value: 60 mA
Detector temperature: 100° C.
Carrier gas: argon
Injection port pressure: 200 kPa

### Attenuation: 2-0

Sample injection volume: 0.5 mL

The following information is derived from the Table 1.

When a calcinated coral is dissolved in water, hydrogen is generated.

When hydrogen substitution is attempted from the outside without calcinating, hydrogen is also generated when the gas is replaced with hydrogen added externally. Furthermore, the H₂ concentration is virtually unchanged.

The above findings suggest that, even if the gas is replaced with hydrogen added externally, the hydrogen does not enter between CaCO₃ layers, but after organic matters (proteins) originally retained between CaCO₃ layers are converted to low molecular weight compounds by carbonization, hydrogen is finally retained in gaps between calcium carbonate layers as hydrogen gas.

FIG. 2(A) shows a compact obtained by granulating a powder for supplementary food in which hydrogen gas is adsorbed and retained, the compact having an enteric-coating surface thereof. FIG. 2(B) shows the powder for a supplementary food contained in an enteric capsule.

Examples of the enteric coating include methacrylic acid copolymer, hydroxypropylmethylcellulose phthalate, hydroxypropylmethylcellulose acetate succinate, carboxymethylcellulose (CMEC), cellulose acetate phthalate, cellulose acetate trimellitate, methacrylic acid-ethyl acrylate copolymer, methacrylic acid-methyl methacrylate copolymer, propylene glycol, sorbitan monolaurate, cellulose acetate phthalate (CAP), cellulose acetate trimellitate, hydroxypropylmethylcellulose phthalate (HPMCP), methacrylate, chitosan, guar gum, pectin, locus bean gum, polyethylene glycol (PEG), and shellac.

Examples of enteric capsules include capsules having the enteric coating solution applied on the surface of a capsule made of gelatin, celluloses, or starch and capsules which are made enteric themselves such as, for example, capsules produced by mixing the above-mentioned gelatin, celluloses, or starch with pectin, algic acid, sodium alginate, calcium alginate, celluloses such as carboxymethylcellulose and cellulose acetate phthalate, methacrylic acid copolymer, or the like.

The above-mentioned gelatin capsules are not dissolved in the gastric acid or not attached to each other when temperature is elevated, and have a high gas barrier property, but are not enteric. However, gelatin can have, an enteric property by ion-crosslinking the NH₂ group of gelatin and the SO₃ group of carrageenan.

Furthermore, enteric capsules may be produced by utilizing a method for producing an emulsion. For example, an aqueous algic acid solution in which hydrogen gas is dissolved to a saturated state is prepared, and a coral powder, an oyster shell powder, a Japanese pearl oyster shell powder, or pearl powder in which the hydrogen gas is adsorbed and retained is dissolved in this aqueous algic acid solution to form a dispersed phase. Meanwhile, an aqueous calcium solution is prepared as a continuous phase.

Then, the dispersed phase and the continuous phase are separated via a partition wall, the dispersed phase is fed into the continuous phase in particles via a through hole formed in the partition wall by applying a pressure to the dispersed phase. Then, algic acid constituting the fed dispersed-phase particles and calcium in the continuous phase are reacted to form an acid-insoluble and alkali-soluble calcium alginate membrane on the surface of dispersed-phase particles. This calcium alginate membrane serves as an enteric capsule.

1. A method for producing a powder for a supplementary food, comprising: crushing coral, seashell or pearl, which contains conchiolin (protein) between CaCO₃ layers; and calcinating this crushed coral, seashell or pearl, in a nonoxidative atmosphere to convert the conchiolin (protein) to low molecular weight compounds, so that hydrogen gas generated during the conversion to low molecular weight compounds is physically adsorbed and retained in a gap left between the CaCO₃ layers compressed by elimination of the conchiolin (protein).

2. A supplementary food comprising: a powder of coral, seashell or pearl obtained by crushing the coral, seashell or pearl, which contains conchiolin (protein) between CaCO₃ layers, and calcinating this crushed coral, seashell or pearl in a nonoxidative atmosphere to convert the conchiolin (protein) to low molecular weight compounds, so that hydrogen gas generated during the conversion to low molecular weight compounds is physically adsorbed and retained in a gap left between the CaCO₃ layers compressed by elimination of the conchiolin (protein), or a compact having the powder molded into a predetermined shape; and an enteric coating applied on the surface of the powder or compact.

3. A supplementary food comprising: a powder of coral, seashell or pearlobtained by crushing the coral, seashell or pearl, which contains conchiolin (protein) between CaCO₃ layers, and calcinating this crushed coral, seashell or pearl in a nonoxidative atmosphere to convert the conchiolin (protein) to low molecular weight compounds, so that hydrogen gas generated during the conversion to low molecular weight compounds is physically adsorbed and retained in a gap left between the CaCO₃ layers compressed by elimination of the conchiolin (protein), or a compact having the powder molded into a predetermined shape; and an enteric capsule containing the powder or compact.
